(19) United States
(12) Patent Application Publication
(10) Pub. No.: US 2009/0325064 A1
(43) Pub. Date: Dec. 31, 2009

(54) ELECTRODE ASSEMBLY AND LITHIUM SECONDARY BATTERY HAVING THE SAME

(75) Inventor: Young-Churl Chang, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/485,746

(22) Filed: Jun. 16, 2009

(30) Foreign Application Priority Data
Jun. 26, 2008 (KR) 10-2008-0060987

(51) Int. Cl. H01M 6/04; H01M 2/16; H01M 4/62; H01M 4/52; H01M 4/50; H01M 4/56; H01M 4/48; H01M 4/42; H01M 4/58

(52) U.S. Cl. 429/188; 429/217; 429/223; 429/224; 429/226; 429/228; 429/229; 429/231; 429/231.2; 429/231.3; 429/231.5; 429/231.8; 429/231.95

(57) ABSTRACT

Provided are an electrode assembly and a secondary battery having the same. The electrode assembly includes a positive electrode including a positive electrode active material layer, a negative electrode including a negative electrode active material layer, and a separator for separating the positive and negative electrodes from each other. The negative electrode active material layer includes a metal capable of alloying with lithium or lithium vanadium oxide (LiV₃O₅), the separator includes a porous layer formed by combining a ceramic material with a binder, and the content of the binder is from about 5 to about 15 wt % with respect to 100 wt % of the porous layer.

Therefore, in the electrode assembly and the lithium secondary battery having the same of the present embodiments, the content of the binder of the porous layer formed by combining a ceramic material with the binder is limited in a high-capacity lithium secondary battery, and thus a secondary battery capable of improving an internal short circuit and realizing high capacity can be provided.

### CROSS-REFERENCE TO RELATED APPLICATION

This application claims the benefit of Korean Patent Application No. 2008-60987, filed Jun. 26, 2008, the disclosure of which is hereby incorporated herein by reference in its entirety.

### BACKGROUND OF THE INVENTION

1. Field of the Invention

The present embodiments relate to an electrode assembly and a lithium secondary battery having the same, and more particularly, to a secondary battery capable of improving an internal short circuit and realizing high capacity in a high-capacity secondary battery.

2. Description of the Related Art

In recent years, the rapid development of small and lightweight portable electronic devices has generated an increasing need for high-capacity, small-sized batteries. In particular, lithium ion secondary batteries can provide an operating voltage of at least about 3.6 V, which is about 3 times higher than nickel-cadmium batteries or nickel-hydrogen batteries widely used in portable electronic devices, and have a higher energy density per unit weight than nickel-cadmium batteries or nickel-hydrogen batteries. For these reasons, research into lithium ion secondary batteries has rapidly progressed.

In a lithium ion secondary battery, electrical energy is generated due to oxidation and reduction reactions, which occur when lithium ions are intercalated/deintercalated at positive and negative electrodes. The lithium ion secondary battery is fabricated by using materials capable of reversibly intercalating/deintercalating lithium ions as positive and negative electrode active materials, and filling an organic electrolyte or polymer electrolyte between the positive and negative electrodes.

The lithium ion secondary battery includes an electrode assembly in which a negative electrode plate and a positive electrode plate with a separator interposed therebetween are wound into a predetermined shape, for example, a jelly-roll, a can for containing the electrode assembly and an electrolyte, and a cap assembly mounted on the can.

Conventionally, although a lithium metal has been used as a negative electrode active material, when the lithium metal was used, the formation of dendrites caused the battery to be short-circuited, and this has led to explosion hazards. Thus, a carbon material is widely used as a negative electrode active material in place of the lithium metal.

However, while the amorphous carbon has a high capacity, it has a large irreversibility during charge and discharge processes. Also, crystalline carbon, e.g., graphite, exhibits a high maximum theoretical capacity of 372 mAh/g, and thus is used as a negative electrode active material. However, its life span is significantly shortened.

In addition, graphite or the carbon based active material exhibits no more than a theoretical capacity of 380 mAh/g, so that when a high-capacity lithium battery is developed, the above-described negative electrode cannot be used.

A material into which research is actively progressing to overcome the above problem includes a metal negative electrode active material or a metal composite negative electrode active material. For example, research into a lithium battery using metals such as aluminum, germanium, silicon, tin, zinc, lead, etc. as negative electrode active materials is underway.

These materials have high capacity and high energy density, and can intercalate/deintercalate more lithium ions than the negative electrode active material using a carbon material, so that a battery having high capacity and high energy density can be fabricated. For example, pure silicon is known to have a high theoretical capacity of 4017 mAh/g.

Conventionally, a single or multiple polyolefin micro-porous polymer layer formed of polypropylene (PP), polyethylene (PE), etc. was used as a separator. However, since the polyolefin separator has a sheet or film shape, when heat is generated due to an internal short circuit or overcharge, pores may be clogged and the sheet-type separator may shrink.

Accordingly, when the sheet-type separator shrinks due to heat generated in the battery, portions of the positive and negative electrodes, which are not separated by the shrunk separator, are brought into contact with each other, thereby causing ignition, rupture, or explosion.

Here, when the conventional polyolefin separator is made of the above-described metal negative electrode active material or metal composite negative electrode active material, instability resulting from the shrunk separator may be made worse.

That is, the metal negative electrode active material or the metal composite negative electrode active material exhibits a high heating value during a charge and discharge process, and thus it causes the separator to shrink more than a case when the carbon negative electrode active material is used.

Also, inorganic particles such as silicon or tin included in the metal negative electrode active material or the metal composite negative electrode active material may be charged to intercalate lithium, so that around 300% to 400% increase in volume is shown. In addition, when the particles are discharged to deintercalate lithium, the inorganic particles shrink, and the repeated charge and discharge cycles cause conductivity between active materials to be deteriorated due to a change in volume in the process of charge and discharge or the negative electrode active material to delaminate from a negative electrode collector, so that the life span is shortened.

Moreover, the increase in volume of the inorganic materials included in the metal negative electrode active material or the metal composite negative electrode active material is higher than that in the carbon negative electrode active material, so that an electrolyte may not be uniformly dispersed on the separator, and the life span may also be shortened. The present embodiments overcome the above problems and also provide additional advantages.

### SUMMARY OF THE INVENTION

Aspects of the present embodiments provide an electrode assembly capable of improving an internal short circuit and realizing high capacity in a high-capacity secondary battery and a lithium second battery having the same.

According to an embodiment, an electrode assembly includes: a positive electrode having a positive electrode active material layer; a negative electrode having a negative electrode active material layer; and a separator for separating the positive electrode from the negative electrode, wherein the negative electrode active material layer includes a metal capable of alloying with lithium or lithium vanadium oxide (LiV₃O₅), the separator includes a porous layer formed by combining a ceramic material with a binder, and the content of the binder is 5 to 15 wt % with respect to the total amount of 100 wt % of the porous layer.

According to another embodiment, a lithium secondary battery includes: an electrode assembly including a positive electrode including a positive electrode active material layer, a negative electrode including a negative electrode active material layer, and a separator for separating the positive and negative electrodes from each other; and an electrolyte, wherein the negative electrode active material layer includes a metal capable of alloying with lithium or lithium vanadium oxide (LiV₃O₅), the separator includes a porous layer formed by combining a ceramic material with a binder, and the content of the binder is 5 to 15 wt % with respect to the total amount of 100 wt % of the porous layer.

According to still another embodiment: a separator for separating a positive electrode having a positive electrode active material layer from a negative electrode having a negative electrode active material layer, wherein the separator includes a porous layer formed by combining a ceramic material with a binder, and the content of the binder is 5 to 15 wt % with respect to the total amount of 100 wt % of the porous layer.

The binder may include polytetrafluoroethylene (PTFE).

Also, the binder may further include a synthetic rubber latex binder or an acrylic rubber with a crosslinking structure.

### DETAILED DESCRIPTION OF THE INVENTION

Reference will now be made in detail to exemplary embodiments illustrated in the accompanying drawings, wherein the thickness of layers, films and regions may be exaggerated for clarity and like reference numerals refer to the like elements throughout.

An electrode assembly including a separator and a secondary battery including the same according to the present embodiments will be described below.

The separator of the present embodiments includes a porous layer formed by combining a ceramic material with a binder, and the ceramic material and the binder are mixed with a solvent to manufacture a paste, so that the porous layer may be formed on a positive electrode, a negative electrode, or both electrodes using the paste.

The porous layer may function as a conventional film-like separator formed of polyethylene (PE) or polypropylene (PP).

The ceramic material may include at least one selected from the group consisting of silica (SiO₂), alumina (Al₂O₃), zirconium oxide (ZrO₂), and titanium oxide (TiO₂), and may include a hydroxide, a ketone, an insulating nitride of each of zirconium, aluminum, silicon, and titanium, or a mixture thereof Here, the insulating nitride is mentioned because a conductive nitride, such as titanium nitride (TiN), is not appropriate for the ceramic material according to the present embodiments.

Polytetrafluoroethylene (PTFE) exhibiting excellent elasticity may be used as the binder.

PTFE whose main ingredient is teflon is used to enhance the flexibility of the porous layer.

Also, the binder may further include a synthetic rubber latex binder or an acrylic rubber with a crosslinking structure.

When the synthetic rubber latex binder or the acrylic rubber with a crosslinking structure is used for the porous layer formed by combining a ceramic material with a binder, since the binding mechanism of the binder is point bonding, insufficient bonding networks may result in insufficiently improved brittle characteristics. However, when the above-described PTFE binder is added to the synthetic rubber latex binder or the acrylic rubber binder with a crosslinking structure to be properly dispersed, the formed results surround the ceramic material like a net, and as a result, the PTFE binder may complement the synthetic rubber latex binder or the acrylic rubber binder with a crosslinking structure to further enhance the flexibility of the porous layer.

Furthermore, since the synthetic rubber latex binder or the acrylic rubber binder with a crosslinking structure is in the form of rubber at room temperature, a spring back phenomenon accompanying an increase in volume to some extent after rolling occurs. However, since it is used together with the PTFE binder, the occurrence of the phenomenon may be prevented.

That is, although a porous layer having a desired thickness may be formed by applying a predetermined degree of pressure to the layer during a press process, when the layer recovers to the original thickness, a jelly roll increases in size, and thus as the jelly roll is inserted or after being inserted into a case, defects are likely to occur. However, when the PTFE binder is used along with the porous layer, the occurrence of defects may be reduced.

The synthetic rubber latex binder may include at least one polymer latex selected from the group consisting of styrene butadiene rubber (SBR) latex, nitrile butadiene rubber (NBR) latex, methyl methacrylate butadiene rubber latex, chloroprene rubber latex, carboxylated styrene-butadiene rubber latex, and modified polyorganosiloxane-based polymer latex.

Also, the acrylic rubber having a crosslinking structure may be obtained by a crosslinking reaction of a polymer or co-polymer of an acrylic main monomer with a crosslinking comonomer. When only the polymer or co-polymer of the acrylic main monomer is used, a coupling structure may be weak and easily cut. However, when the crosslinking comonomer is added into the polymer or co-polymer of the acrylic main monomer, the crosslinking comonomer combines with the polymer or co-polymer of the acrylic main monomer, so that a tighter net structure can be formed. As cross-linking degree increases, it becomes more difficult to swell a polymer having a net structure in a solvent. The acrylic rubber binder having the cross-linking structure may have a 3-dimensional cross-linking structure having 2 to 10 cross-linking points, and more specifically, 4 to 5 cross-linking points, based on 10,000 molecular weight units of a main chain molecule. Thus, the acrylic rubber having the cross-linking structure according to the present embodiments may have good resistance to swelling in the electrolyte.

The ceramic material may decompose at a temperature of about 1,000° C. or higher, and the acrylic rubber binder having the cross-linking structure may decompose at a temperature of about 250° C. or higher, so that the heat resistance of a secondary battery can be increased to improve battery safety with regard to an internal short circuit.

The acrylic main monomer may include one or more materials selected from the group consisting of: one alkoxyalkyl acrylate selected from the group consisting of methoxymethyl acrylate, methoxyethyl acrylate, ethoxyethyl acrylate, butoxyethylacrylate, methoxyethoxyethyl acrylate, and dicyclopentenyloxyethyl acrylate; one alkenyl acrylate or alkenyl methacrylate selected from the group consisting of vinyl methacrylate, vinyl acrylate, allyl methacrylate, 1,1-dimethylpropenyl methacrylate, 1,1-dimethylpropenyl acrylate, 3,3-dimethylbutenyl methacrylate, and 3,3-dimethylbutenyl acrylate; one unsaturated dicarboxylic acid ester selected from divinyl itaconate and divinyl maleate; one vinyl group-containing ether selected from vinyl 1,1-dimethylpropenyl ether and vinyl 3,3-dimethylbutenyl ether; 1-acryloyloxy-1-phenylethene; and methyl methacrylate.

The cross-linking comonomer may include one or more of: an alkyl acrylate such as 2-ethylhexyl acrylate, methyl acrylate, ethyl acrylate, propyl acrylate, butyl acrylate, octyl acrylate, and iso-octyl acrylate; an alkenyl chloroacetate, such as vinyl chloroacetate and acryl chloroacetate; a glycidyl group-containing ester or ether such as glycidyl acrylate, vinylglycidyl ether, and acryl glycidyl ether; an unsaturated carboxylic acid such as acrylic acid, methacrylic acid, and maleic acid; 2-chloroehtyl vinyl ether; chloromethyl styrene; and acrylonitrile.

The content of the binder may range from about 5 wt % to about 15 wt % with respect to the total amount of 100 wt % of the porous layer formed by combining a ceramic material with a binder.

The binder serves to bind ceramic powders or to bond a ceramic layer to an active material layer. When the content of the binder is less than about 5 wt %, the flexibility of the ceramic layer is deteriorated, bonding force of the ceramic layer becomes insufficient, and the scratch strength of the ceramic layer is degraded, so that it is easily scratched. When a high-capacity negative electrode active material exhibiting significant volume expansion is used, the volume expansion of the negative electrode active material may lead the maintenance of the porous layer to be difficult. Also, when it exceeds about 15 wt %, pores between ceramic powders may be clogged, and as a result, smooth movement of the lithium ions may be prevented, so that a capacity is dropped.

Next, an electrode assembly including a separator and a secondary battery having the same include a positive electrode and a negative electrode in the present embodiments.

The positive electrode includes a positive electrode active material capable of intercalating/deintercalating lithium ions and a positive electrode collector where the positive electrode active material is coated. The positive electrode active material may be, for example, cobalt, manganese or nickel and one or more of lithium composite oxides, however the positive electrode active material of the present embodiments is not limited to such materials.

Examples of the positive electrode active material may include the following lithium containing compounds.

LiₓMn_{1-y}MyA₂ (1)

LiₓMn_{1-y}M_{y}O_{2-z}X_{z} (2)

LiₓMn₂O_{4-z}X_{z} (3)

LiₓMn_{2-y}M_{y}M′_{z}A₄ (4)

LiₓCo_{1-y}M_{y}A₂ (5)

LiₓCo_{1-y}M_{y}O_{2-z}X_{z} (6)

LiₓNi_{1-y}M_{y}A₂ (7)

LiₓNi_{1-y}M_{y}O_{2-z}X_{z} (8)

LiₓNi_{1-y}Co_{y}O_{2-z}X_{z} (9)

LiₓNi_{1-y-z}Co_{y}M_{z}A_{α} (10)

LiₓNi_{1-y-z}Co_{y}M_{z}O_{2-α}X_{α} (11)

LiₓNi_{1-y-z}Mn_{y}M_{z}A₆₀ (12)

LiₓNi_{1-y-z}Mn_{y}M_{z}O_{2-α}X₆₀ (13)

(wherein 0.9≦x≦1.1, 0≦y≦0.5, 0≦z≦0.5, and 0≦α≦2, M may be equal to or different from M′, and may be Al, Co, K, Na, Ca, Si, Ti, Sn, V, Ge, Ga, B, As, Zr, Mn, Cr, Fe, Sr, V or a rare earth element, A may be O, F, S or P, and X may be F, S or P.)

The negative electrode includes a negative electrode active material and a negative electrode collector where the negative electrode active material is coated. In the present embodiments, a negative electrode active material including metals capable of alloying with lithium and lithium vanadium oxide (LiV₃O₅) may be used as the negative electrode active material.

The negative electrode active material including metals capable of alloying with lithium may be solely used as the negative electrode active material, and a compound mixed with a carbon material capable of reversibly intercalating/deintercalating lithium may be used as the negative electrode active material.

The metal may include at least one metal capable of alloying with lithium or at least one metal oxide thereof. Examples of metals capable of alloying with lithium include Sn, Si, Ge, Cr, Al, Mn, Ni, Zn, Co, In, Cd, Bi, Pb and V, and the metal oxide may include at least one of SnO₂, SnO, SiO₂, SiO, GeO, CrO₂, Cr₂O₃, Al₂O₃, Al(OH)₃, MnO₂, Mn₂O₃, NiO₂, NiO, ZnO, CoO, InO₃, CdO, Bi₂O₃, PbO, or V₂O₅, which can be formed by reduction of the metal.

The carbon material capable of reversibly intercalating/deintercalating lithium may include at least one of artificial graphite, natural graphite, graphitized carbon fiber, graphitized mesocarbon microbeads, and amorphous carbon.

The negative electrode active material including the metals capable of alloying with lithium or the lithium vanadium oxide has a high capacity and high energy density and is able to reversibly charge and discharge lithium like the carbon material, so that it can improve capacity and energy density of the negative electrode active material. Further, it can intercalate and deintercalate more lithium ions than the negative electrode active material using the carbon material, so that a high-capacity battery may be fabricated.

In the present embodiments, the high capacity battery is defined as a battery having a battery capacity of about 3000 mAh or higher.

In a case of the negative electrode active material including a metal having a high capacity or a lithium vanadium oxide, the above-described inorganic particles such as silicon or tin included in the negative electrode active material may be charged to intercalate lithium, so that about a 300% to 400% increase in volume is shown. Further, the volume expansion characteristics may cause conductivity between the active materials to be deteriorated due to a change in volume during the charge and discharge process or the negative electrode active material to delaminate from the negative electrode collector, so that the life span is shortened.

Also, the volume expansion characteristics may be more significant than a case when the conventional carbon negative electrode active material is used, so that an electrolyte is unequally dispersed on a polyolefin-based separator, and thus the life span is shortened.

In the present embodiments, the porous layer formed by combining a ceramic material with a binder is used as the separator, so that the porous layer prevents volume expansion of the negative electrode active material. As a result, deteriorated conductivity and delamination of the negative electrode active material may be overcome. In addition, the porous layer has more pores than the conventional polyolefin-based separator, and thus excellent absorption of electrolyte is exhibited. Accordingly, the electrolyte is maintained to be uniformly dispersed on the separator, so that the life span is prevented from being shortened.

In some embodiments, since PTFE having excellent elasticity is used as the binder of the porous layer, the flexibility of the porous layer is increased, so that volume expansion of the negative electrode active material may be more efficiently restrained. Furthermore, for example, on the assumption that a porous layer having the same bonding strength as the conventional porous layer is formed, since the binder having excellent elasticity is used, less amount of the binder is used, and an amount of the ceramic material is increased. Accordingly, the volume expansion of the negative electrode active material may be efficiently restrained, and absorption of electrolyte may be increased, so that a secondary battery having excellent safety regardless of the occurrence of an internal short circuit in a high-capacity battery may be provided.

In some embodiments the positive electrode collector may comprise aluminum (Al) or an Al alloy, and the negative electrode collector may comprise Copper (Cu) or a Cu alloy. Each of the positive and negative electrode collectors may be provided in the form of a foil, a film, a sheet, a punched structure, a porous structure, or a foam structure.

The porous layer of the present embodiments may be formed to be attached to at least one surface of one of the positive and negative electrodes.

First, an electrode slurry composition formed by dispersing an active material, a binder and a conductive agent in a solvent is coated on the electrode collector to fabricate a positive electrode and a negative electrode. Then, a porous layer liquid is coated on the electrode where the active material is coated, and the solvent is removed from the coated porous layer liquid through baking, so that the porous layer may be formed.

Also, the porous layer may be formed by forming a porous layer liquid in which ceramic material particles in a mixed liquid of the binder and the solvent forms a uniform disperse phase, and dipping the electrode where the active material is coated into the porous layer liquid.

Further, the porous layer may be formed by spraying the porous layer liquid onto the electrode where the active material is coated.

The porous layer may function as a film-like separator made of a conventional polyolefin-based resin layer formed of polyethylene (PE) and polypropylene (PP), and also, the porous layer may function as a separator together with a conventional film-like separator formed of polyethylene (PE) and polypropylene (PP).

The thickness of the porous layer may be adjusted taking ion conductivity and energy density into account, so that the porous layer may be formed to a thickness of about 1 to about 40 μm, preferably from about 3 to about 10 μm. When the thickness of the porous layer is thinner than 1 μm, strength is likely to be deteriorated, and when it is thicker than 40 μm, it may be unfavorable in terms of energy density.

The porous layer of the present embodiments may be formed on a positive electrode or a negative electrode or on both, and both electrodes may be stacked or wound after being stacked to form an electrode group. As describe above, since the porous layer itself may function as the separator, installing a separator between the two electrodes may be omitted.

When an initial portion of the conventional polyolefin-based film separator is damaged by initial heating due to an internal short circuit, additional portions adjacent to the damaged portion continue to shrink or melt, thereby increasing the area of the film separator that is lost by combustion. Consequently, the conventional battery may suffer from a harder or more severe short circuit. However, an electrode where a porous layer is formed may suffer only slight damage at a location where an internal short circuit occurs, and the short circuit does not extend to a greater area. In addition, even when the electrode where the porous layer is formed is overcharged, it generates a soft short rather than the hard short to continuously consume overcharge current. Accordingly, a specific voltage of about 5V to about 6V and a battery temperature of about 100° C. or lower are maintained, so that overcharge safety may be enhanced.

In some embodiments of the high-capacity negative electrode active material of the present embodiments, a heating value during the charge and discharge process is high, and thus the separator shrinks more than the carbon negative electrode active material. However, as the porous layer formed by combining a ceramic material with a binder is used as the separator, stability may be improved.

Moreover, since the porous layer formed by combining a ceramic material with a binder is used as the separator, the porous layer prevents volume expansion of the negative electrode active material, so that the conductivity may be prevented from being deteriorated and the negative electrode active material may be prevented from delaminating. In addition, the porous layer has more pores than the conventional polyolefin-based separator, and thus absorption of electrolyte is improved, so that the electrolyte may be uniformly dispersed on the separator, thereby preventing the life span from being shortened.

Furthermore, a binder having improved flexibility is used for the porous layer, and the content of the binder with respect to the total amount of 100 wt % of the porous layer is controlled, so that a battery having excellent stability and life span regardless of the occurrence of an internal short circuit in a high-capacity battery may be provided.

The secondary battery of the present embodiments having an electrode assembly including a separator also includes the electrolyte.

According to the present embodiments, the electrolyte may contain a nonaqueous organic solvent. The nonaqueous organic solvent may include carbonate, ester, ether, or ketone. The carbonate may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC). The ester may include butyrolactone (BL), decanolide, valerolactone, mevalonolactone, caprolactone, n-methyl acetate, n-ethyl acetate, or n-propyl acetate. The ether may include dibutyl ether, and the ketone may include polymethylvinyl ketone. However, the present embodiments are not limited to the above-described kinds of nonaqueous organic solvents.

When the nonaqueous organic solvent is a carbonate organic solvent, a mixture of a cyclic carbonate and a chain carbonate may be used as the nonaqueous organic solvent. In this case, the cyclic carbonate may be mixed with the chain carbonate in a volume ratio of from about 1:1 to about 1:9, and preferably, a volume ratio of from about 1:1.5 to about 1:4, in order to obtain good electrolyte performance.

The electrolyte according to the present embodiments may be obtained by adding an aromatic hydrocarbon organic solvent to the carbonate solvent. The aromatic hydrocarbon organic solvent may include an aromatic hydrocarbon compound.

For example, the aromatic hydrocarbon organic solvent may include benzene, fluorobenzene, chlorobenzene, nitrobenzene, toluene, fluorotoluene, trifluorotoluene, or xylene. When the electrolyte further contains the aromatic hydrocarbon organic solvent, the carbonate organic solvent may be mixed with the aromatic hydrocarbon organic solvent in a volume ratio of from about 1:1 to about 30:1, in order to obtain good electrolyte performance.

Furthermore, the electrolyte according to the present embodiments may contain lithium salts, which function as a source of lithium ions, to enable basic operation of the lithium ion secondary battery. For example, the lithium salts may include one or more of LiPF₆, LiBF₄, LiSbF₆, LiAsF₆, LiClO₄, LiCF₃SO₃, LiN(CF₃SO₂)₂, LiN(C₂F₅SO₂)₂, LiAlO₄, LiAlC₄, LiN(CₓF₂ₓ₊₁SO₂)(CyF₂ₓ₊₁SO₂) (wherein x and y are natural numbers), LiSO₃CF₃, and a mixture thereof.

The lithium salts may be used in a concentration of from about 0.6 to about 2.0M, and preferably, from about 0.7 to about 1.6M. When the concentration of the lithium salts is less than about 0.6M, the electrolyte has low conductivity and does not exhibit good performance, and when the concentration of the lithium salts is more than about 2.0M, the electrolyte has high viscosity and reduces lithium ion mobility.

The porous layer formed by combining a ceramic material with a binder is formed on the positive electrode, the negative electrode or both electrodes, and then the positive and negative electrodes are stacked, or both stacked and wound, to form an electrode group. The electrode group is injected into and contained in a can or similar case, thereby completing fabrication of the lithium ion secondary battery.

Further, the shape of the secondary battery formed by the above method is not limited and may be, for example, cylindrical, prismatic, or pouch-shaped, etc.

Exemplary embodiments, which do not limit the scope of the present disclosures and comparative examples will be described below in the following Examples.

### EXAMPLE 1

LiCoO₂ as a positive electrode active material, polyvinylidene fluoride (PVDF) as a binder, and carbon as a conductive agent were mixed in a weight ratio of 92:4:4 and dispersed in N-methyl-2-pyrrolidone, thereby producing a positive electrode slurry. The positive electrode slurry was coated on an aluminum foil, dried, and rolled to form a positive electrode. A metal composite active material of silicon and graphite as a negative electrode active material, styrene-butadiene rubber as a binder, and carboxymethylcellulose (CMC) as a viscosity agent were mixed in a weight ratio of 96:2:2 and dispersed in water, thereby producing a negative electrode slurry. The negative electrode slurry was coated on a copper foil, dried, and rolled to form a negative electrode.

Also, alumina (Al₂O₃) was used as a ceramic material, PTFE mixed with an acrylic rubber was used as a binder, and the formed results were diluted into a mixed solvent of N-methyl-2-pyrrolidone/cyclohexanone, thereby producing a porous layer paste. The porous layer formed to a thickness of 6 μm was coated between the negative electrode and the positive electrode to form a separator. Then, the formed results were rolled and pressed to be inserted into a cylindrical can.

The binder was added in an amount of 5 wt % with respect to the total amount of 100 wt % of the porous layer.

An electrolyte was inserted into the cylindrical can to complete fabricating the lithium secondary battery.

### EXAMPLE 2

The same process as in Embodiment 1 was performed except that the binder was added in an amount of 10 wt % with respect to the total amount of 100 wt % of the porous layer.

### EXAMPLE 3

The same process as in EXAMPLE 1 was performed except that the binder was added in an amount of 15 wt % with respect to the total amount of 100 wt % of the porous layer.

### COMPARATIVE EXAMPLE 1

The same process as in EXAMPLE 1 was performed except that a polyethylene resin layer was used as the separator in place of the porous layer.

### COMPARATIVE EXAMPLE 2

The same process as in EXAMPLE 1 was performed except that the binder was added in an amount of 3 wt % with respect to the total amount of 100 wt % of the porous layer.

### COMPARATIVE EXAMPLE 3

The same process as in EXAMPLE 1 was performed except that the binder was added in an amount of 20 wt % with respect to the total amount of 100 wt % of the porous layer.

A rolling press test was carried out by inserting metal foreign substances into the lithium batteries of EXAMPLES 1 to 3 and COMPARATIVE EXAMPLES 1 to 3 to cause an internal short-circuiting phenomenon. In the rolling press test, a fully charged battery was disassembled, and metal foreign substances such as Fe, Ni, etc. were inserted into the upper part of the negative electrode plate of a jelly roll to wind the formed results again. Afterwards, a pressure of 1 to 3 kgf was applied and the rolling was performed 10 times. When no smoke or ignition was found, it was indicated as “OK”, and when any smoke or ignition was found, it was indicated as “NG”.

Also, the lithium batteries of EXAMPLES 1 to 3 and COMPARATIVE EXAMPLES 1 to 3 were cut-off-charged to 4.2V using CC-CV at a charge/discharge rate of 0.5 C, and then cut-off-charged to 3.0V using CC at a charge/discharge rate of 1 C, 100 times. 100 cycles of charge and discharge of the battery were performed. Afterwards, a 100th cycle capacity (%) was measured and a capacity maintenance rate at the 100th cycle was calculated

The measured results are represented in the following Table 1.

TABLE 1

| | | Content of | Internal short | 100^{th} |
|---|---|---|---|---|
| | | Binder | circuit | Capacity |
| Identification | Separator | (wt %) | characteristics | (%) |
| EXAMPLE 1 | Porous Layer | 5 | OK | 82 |
| EXAMPLE 2 | Porous Layer | 10 | OK | 92 |
| EXAMPLE 3 | Porous Layer | 15 | OK | 85 |
| COMPARATIVE | polyethylene | — | NG | 52 |
| EXAMPLE 1 | resin layer | | | |
| COMPARATIVE | Porous Layer | 3 | OK | 73 |
| EXAMPLE 2 | | | | |
| COMPARATIVE | Porous Layer | 20 | OK | 68 |
| EXAMPLE 3 | | | | |

Referring to the results represented in Table 1, in EXAMPLES 1 to 3, a porous layer formed by combining a ceramic material with a binder was used as a separator, and the binder was added in an amount of 5 to 15 wt %. In the EXAMPLES, despite the internal short circuit, no smoke or ignition was found, and excellent life span was observed.

However, in COMPARATIVE EXAMPLE 1, a polyethylene resin layer was used as the separator. In COMPARATIVE EXAMPLE 1, ignition was found during an internal short circuit, so that internal short circuit characteristics were deteriorated, and in particular, the life span was significantly shortened due to volume expansion characteristics of the negative electrode active material.

Further, in COMPARATIVE EXAMPLE 2, since the porous layer, in which the content of the binder was 3 wt %, an example of less than 5 wt %, was used, so that enhanced internal short circuit characteristics were observed. However, the content of the binder was extremely low, so that volume expansion characteristics of the negative electrode active material were not efficiently restrained, and thus deteriorated life span characteristics were observed. It is appreciated that since the content of the binder was extremely low, the volume expansion characteristics of the negative electrode active material led the maintenance of the porous layer to be difficult.

Moreover, in COMPARATIVE EXAMPLE 3, since the porous layer, in which the content of the binder was 20 wt %, e.g., more than 15 wt %, was used, enhanced internal short circuit characteristics were observed. However, since the content of the binder is extremely high, life span characteristics may be worse than those in Comparative example 2. This is because pores between ceramic powders were clogged by the binder, and thus smooth movement of lithium ions was prevented.

Therefore, in the present embodiments, in which a metal capable of alloying with lithium or lithium vanadium oxide is used, a porous layer formed by combining a ceramic material with a binder may be used as a separator, and the content of the binder may be 5 to 15 wt % with respect to the total amount of 100 wt % of the porous layer.

In an electrode assembly and a lithium secondary battery having the same of the present embodiments, a porous layer formed by combining a ceramic material with a binder is used as a separator in a high-capacity lithium secondary battery. Also, the content of the binder is limited, so that a secondary battery capable of improving an internal short circuit and realizing high capacity can be provided.

In addition, in the porous layer formed by combining a ceramic material with a binder, the binder is formed of a material having prominent elasticity, so that a secondary battery capable of improving an internal short circuit and realizing high capacity can be provided.

Although some embodiments have been shown and described, it would be appreciated by those skilled in the art that changes may be made without departing from the principles and spirit of the present disclosure, the scope of which is defined in the claims and their equivalents.

What is claimed is:

1. An electrode assembly comprising:
a positive electrode having a positive electrode active material layer;
a negative electrode having a negative electrode active material layer; and
a separator for separating the positive electrode from the negative electrode,
wherein the negative electrode active material layer includes at least one of a metal capable of alloying with lithium or lithium vanadium oxide (LiV₃O₅) and a metal oxide,
wherein the separator includes a porous layer formed by combining a ceramic material with a binder, and
wherein the content of the binder is from about 5 to about 15 wt % with respect to 100 wt % of the porous layer.

2. The electrode assembly of claim 1, wherein the metal capable of alloying with lithium or lithium vanadium oxide (LiV₃O₅) includes at least one Sn, Si, Ge, Cr, Al, Mn, Ni, Zn, Co, In, Cd, Bi, Pb and V, and wherein the metal oxide includes at least one of SnO₂, SnO, SiO₂, SiO, GeO, CrO₂, Cr₂O₃, Al₂O₃, Al(OH)₃, MnO₂, Mn₂O₃, NiO₂, NiO, ZnO, CoO, InO₃, CdO, Bi₂O₃, PbO, and V₂O₅, wherein the metal oxides are formed by reduction of the metal.

3. The electrode assembly according to claim 1, wherein the metal capable of alloying with lithium is a compound mixed with a carbon material capable of reversibly intercalating/deintercalating lithium,
wherein the carbon material capable of reversibly intercalating/deintercalating lithium includes at least one material selected from the group consisting of artificial graphite, natural graphite, graphitized carbon fiber, graphitized mesocarbon microbeads, and amorphous carbon.

4. The electrode assembly according to claim 1, wherein the binder includes polytetrafluoroethylene (PTFE).

5. The electrode assembly according to claim 4, wherein the binder further includes a synthetic rubber latex binder or an acrylic rubber with a crosslinking structure.

6. The electrode assembly according to claim 1, wherein the ceramic material includes at least one material selected from the group consisting of silica (SiO₂), alumina (Al₂O₃), zirconium oxide (ZrO₂), and titanium oxide (TiO₂).

7. A lithium secondary battery comprising:
an electrode assembly comprising a positive electrode including a positive electrode active material layer, a negative electrode including a negative electrode active material layer, and a separator for separating the positive and negative electrodes from each other; and
an electrolyte,
wherein the negative electrode active material layer includes at least one of a metal capable of alloying with lithium or lithium vanadium oxide (LiV₃O₅) and a metal oxide, the separator includes a porous layer formed by combining a ceramic material with a binder, and wherein the content of the binder is from about 5 to about 15 wt % with respect to the total amount of 100 wt % of the porous layer

8. The lithium secondary battery according to claim 7, wherein the metal capable of alloying with lithium or lithium vanadium oxide (LiV₃O₅) includes at least one of Sn, Si, Ge, Cr, Al, Mn, Ni, Zn, Co, In, Cd, Bi, Pb and V, and the metal oxide includes includes at least one of SnO₂, SnO, SiO₂, SiO, GeO, CrO₂, Cr₂O₃, Al₂O₃, Al(OH)₃, MnO₂, Mn₂O₃, NiO₂, NiO, ZnO, CoO, InO₃, CdO, Bi₂O₃, PbO, and V₂O₅, wherein the metal oxides are formed by reduction of the metal.

9. The lithium secondary battery according to claim 7, wherein the metal capable of alloying with lithium or lithium vanadium oxide (LiV₃O₅) is a compound mixed with a carbon material capable of reversibly intercalating/deintercalating lithium,
wherein the carbon material capable of reversibly intercalating/deintercalating lithium includes at least one material selected from the group consisting of artificial graphite, natural graphite, graphitized carbon fiber, graphitized mesocarbon microbeads, and amorphous carbon.

10. The lithium secondary battery according to claim 7, wherein the binder includes polytetrafluoroethylene (PTFE).

11. The lithium secondary battery according to claim 10, wherein the binder further includes a synthetic rubber latex binder or an acrylic rubber with a crosslinking structure.

12. The lithium secondary battery according to claim 7, wherein the ceramic material includes at least one material selected from the group consisting of silica (SiO₂), alumina (Al₂O₃), zirconium oxide (ZrO₂), and titanium oxide (TiO₂).

13. A lithium secondary battery having a battery capacity of about 3000 mAh or higher, the lithium secondary battery comprising:
a separator for separating a positive electrode having a positive electrode active material layer from a negative electrode having a negative electrode active material layer,
wherein the separator includes a porous layer formed by combining a ceramic material with a binder, and the content of the binder is from about 5 to about 15 wt % with respect to the total amount of 100 wt % of the porous layer.

14. The lithium secondary battery according to claim 13, wherein the negative electrode active material layer includes at least one of a metal capable of alloying with lithium or lithium vanadium oxide (LiV₃O₅) or a metal oxide.

15. The lithium secondary battery according to claim 14,
wherein the metal capable of alloying with lithium or lithium vanadium oxide (LiV₃O₅) includes at least one of Sn, Si, Ge, Cr, Al, Mn, Ni, Zn, Co, In, Cd, Bi, Pb and V, and the metal oxide includes at least one of SnO₂, SnO, SiO₂, SiO, GeO, CrO₂, Cr₂O₃, Al₂O₃, Al(OH)₃, MnO₂, Mn₂O₃, NiO₂, NiO, ZnO, CoO, InO₃, CdO, Bi₂O₃, PbO, and V₂O₅, wherein the metal oxides are formed by reduction of the metal.

16. The lithium secondary battery according to claim 14, wherein the metal capable of alloying with lithium or lithium vanadium oxide (LiV₃O₅) is a compound mixed with a carbon material capable of reversibly intercalating/deintercalating lithium,
wherein the carbon material capable of reversibly intercalating/deintercalating lithium includes at least one material selected from the group consisting of artificial graphite, natural graphite, graphitized carbon fiber, graphitized mesocarbon microbeads, and amorphous carbon.

17. The lithium secondary battery according to claim 13, wherein the binder includes polytetrafluoroethylene (PTFE).

18. The lithium secondary battery according to claim 17, wherein the binder further includes a synthetic rubber latex binder or an acrylic rubber with a crosslinking structure.

19. The lithium secondary battery according to claim 13, wherein the ceramic material includes at least one material selected from the group consisting of silica (SiO₂), alumina (Al₂O₃), zirconium oxide (ZrO₂), and titanium oxide (TiO₂).

20. The lithium secondary battery according to claim 13, wherein the electrolyte contains a nonaqueous organic solvent and a lithium salt.
